(19) United States
(12) Patent Application Publication
(10) Pub. No.: US 2007/0184321 A1
(43) Pub. Date: Aug. 9, 2007

(54) Compression device for a fuel cell stack

(75) Inventors: Dietmar Mirsch, Kirchheim (DE); Bernd Schall, Giengen (DE); Markus Steinhauser, Zell (DE)

Correspondence Address: CROWELL & MORING LLP;INTELLECTUAL PROPERTY GROUP, P.O. BOX 14300, WASHINGTON, DC, 20044-4300, US

(73) Assignee: NuCellSys GmbH, Kirchheim/Teck-Nabern (DE)

(21) Appl. No.: 11/702,079

(22) Filed: Feb. 5, 2007

(30) Foreign Application Priority Data
Feb. 6, 2006 (DE) 20 2006 005 251.8
Apr. 4, 2006 (DE) 102006015572.6

(51) Int. Cl. H01M 8/04

(52) U.S. Cl. 429/26; 429/37; 429/13

(57) ABSTRACT

A compression device for compression of an oxidant for a fuel cell stack includes an oxidant compressor for compressing the oxidant, and an oxidant cooler for cooling the compressed oxidant. The oxidant compressor and the oxidant cooling device are connected to a common coolant circuit.

### BACKGROUND AND SUMMARY OF THE INVENTION

This application claims the priority of German patent document 10 2006 015 572.6, filed Feb. 6, 2006, the disclosure of which is expressly incorporated by reference herein.

The invention relates to a device for compression of an oxidant in a fuel cell stack, the device having a compressor for compressing the oxidant and a cooler for cooling the compressed oxidant, with the compressor and the cooler being connected to a common coolant circuit.

Fuel cell stacks generate electric energy by an electrochemical reaction of a fuel, such as hydrogen, and an oxidant, such as oxygen or ambient air. The operation of a fuel cell stack requires ancillary equipment for conditioning the fed expendable gases or controlling the operating temperature of the fuel cell stack.

Normally, the oxidant is compressed and cooled during the conditioning of the fed expandable gases. A similar arrangement of ancillary equipment is disclosed, for example, in European Patent Document EP 0 638 712 A1. This document discloses a coolant circuit for a fuel cell stack, in which case a bypass pipe is provided parallel to the fuel cell stack. The bypass pipe includes the drive unit of a compressor for supplying air to the fuel cell stack, and a heat exchanger is provided for cooling the air fed to the fuel cell stack.

One object of the invention is to provide a compression device which permits a good conditioning of the fed oxidant.

This and other objects and advantages are achieved by the compression device according to the invention, which is suitable and/or constructed for a fuel cell stack. The fuel cell stack preferably has a plurality of fuel cells which are implemented particularly in the PEM construction (polymer electrolyte membrane) construction, and may be constructed for use in a vehicle. The compression device compresses and/or cools, the oxidant required for the electro-chemical reaction in the fuel cells, particularly as a function of additional operating parameters, such as the load, performance demand or operating temperature of the fuel cells.

For this purpose, the compression device comprises two assemblies, an oxident compressor and an oxidant cooler, which are preferably integrated in a common constructional unit, such that, for replacement and/or repair purposes, the constructional unit can be separated nondivided and/or in one piece from the fuel cell stack.

In this case, the oxidant compressor is used to compress the oxidant, particularly of ambient air, preferably with the degree of the compression being controllable and/or adjustable. As a result of the compression, a larger amount of oxidants can be made available to the fuel cell stack, to increase its generation of current, particularly as a function of the load. In the flow direction of the oxidant, the oxidant cooler is connected behind the compressor, and cools it.

This arrangement takes into account the fact that, as a result of the compression of a gas, its temperature is raised. The cooling of the compressed gas, on the one hand, prevents the fuel cell stack from being heated unnecessarily, and in addition, the reduction of the temperature leads to a higher density of the oxidant at the same pressure. Thus, the fed mass of the oxidant is increased, and the generating of current can thereby be increased (corresponding to the feeding of fuel).

The oxidant compressor and the oxidant cooler are connected to a common coolant circuit having a liquid coolant, and can be actively cooled to lower the temperature of the oxidant.

The oxidant compressor and the oxidant cooler are preferably connected fluidically parallel to one another in the coolant circuit.

The compression device is preferably constructed such that the coolant flow is divided into at least two partial flows. A first partial flow is guided through the oxidant compressor and, fluidically parallel thereto, a second partial flow is guided through the oxidant cooler. The first and the second partial flow are fluidically guided together again and/or combined behind the oxidant compressor and the oxidant cooler.

This construction is based on the recognition that the parallel arrangement of cooling components for the oxidant, (the oxidant compressor and the oxidant cooler) in the coolant circuit surprisingly permits a reduction of the size of the compression device. This advantage is substantiated by the fact that coolant of the same temperature is fed to both cooling components and therefore, while the cooling capacity is the same, particularly the oxidant cooling device can have a smaller and more compact design than known from the state of the art. Another effect is an increase in the robustness of the compression device, because the embodiment according to the invention tolerates a higher permissible pressure drop in the coolant circuit. This advantage is based on the circumstance that, as a result of the parallel connection, the same pressure conditions exist at the inlets of both cooling components and an oxidant cooling device connected on the output side with respect to the coolant, is not, as known from the state of the art, acted upon by a lower coolant pressure.

Similar advantages are achieved in a further embodiment of the invention, in which the fuel cell stack is fluidically coupled in parallel with respect to the oxidant cooler. By means of this construction, two essential components in the coolant circuit of a fuel cell are cooled by the coolant, which is not already preheated by another large heat source. In this manner, these essential components are, on the one hand, cooled by means of a coolant having a minimally available coolant temperature, such that the energy yield from the fed fuel is optimized by the fuel cell. In addition, the regulating or control expenditures of the coolant circuit are reduced, because the coolant is fed to these essential components with a defined coolant temperature, which is not constantly changed by the connection of auxiliary consuming devices.

In another embodiment of the invention, the fuel cell stack, the oxidant compressor, the oxidant cooler and/or additional components (such as driving motors or the like) are arranged in parallel in the coolant circuit. This construction has the advantage that the coolant flowing into the compression device is not preheated by the fuel cell stack before the passage through the compressor and/or the oxidant cooler and/or additional components. However, the control and regulation expenditures of the coolant circuit rise with the number of the parallel-connected components to be cooled. On the other hand, the robustness of the combination of the fuel cell stack and the compression device is further improved because, as mentioned above, a parallel-connected combination is particularly tolerant with respect to pressure drops in the coolant supply.

It is also possible to arrange the oxidant cooler, the oxidant compressor and the fuel cell stack in a fluidically serial manner. This alternative is less preferable, however, because of the higher coolant temperature and the lower tolerance.

In another embodiment of the invention, the compression device has water injection cooling at the oxidant inlet into the compression device in order to cool the inflowing oxidant. Particularly preferably but not limited to the combination with the water injection cooling, the compression device has a liquid-based sealing-off of the effective areas of the compression device. This development has the advantage that the oxidant is moistened by the supply of water for the water injection cooling and/or by the liquid-based sealing, which counteracts a drying-out of the membrane between the anode and cathode area in the fuel cell stack.

As an alternative, the compression device is constructed as a dry-operation compressor so that any necessary moistening of the oxidant takes place by an assembly connected on the output side. This alternative is advantageous because contamination of the compressor caused by fed liquid is excluded as a result of the system.

The compressor is preferably based on the displacement principle, so that the pressure is generated by the reduction of an operating space within the oxidant compressor. In particular, the oxidant compressor is constructed as a timed piston compressor or preferably as a rotary screw compressor.

The cooling of the oxidant in the compression device by means of the coolant from the coolant circuit is preferably implemented such that the oxidant does not directly come in contact with the coolant. In a particularly preferred embodiment, at least one rotor in the rotary screw compressor has a cooled construction.

The oxidant cooler preferably comprises a heat exchanger which withdraws heat from the compressed oxidant by way of contact surfaces cooled by means of the coolant.

In a preferred embodiment, the flow-through ratio between the coolant flowing through the oxidant compressor and the coolant flowing through the oxidant cooler is statically and/or dynamically adjustable and/or controllable, particularly independently of one another, by means of throttle devices. As an alternative, the flow-through ratio can also be controlled by a three-way valve at a junction to the oxidant compressor and to the oxidant cooler at the inlet or at the outlet of the compression device.

As an alternative (or in addition), a valve is arranged at the inlet and/or outlet of the compression device, by which the entire coolant flow-through can be adjusted and/or controlled. It is preferably provided that the entire coolant flow through the compression device can be adjusted and/or controlled independently or uncoupled from the flow through the fuel cell stack.

The oxidant compressor, the oxidant cooler, the throttle device, and/or the valve can preferably be controlled and/or regulated as a function of additional operating parameters, such as the operating temperature of the fuel cell stack, the load, etc., by means of a higher-ranking control device.

Other objects, advantages and novel features of the present invention will become apparent from the following detailed description of the invention when considered in conjunction with the accompanying drawings.

### BRIEF DESCRIPTION OF THE DRAWINGS

The single FIGURE is a view of an embodiment of a compression device according to the invention in a coolant circuit, illustrating the flow.

### DETAILED DESCRIPTION OF THE DRAWINGS

The FIGURE illustrates a coolant circuit 1 for a fuel cell stack 2 which comprises several fuel cells, preferably in a PEM construction. Such a coolant circuit is used, for example, in vehicles operated by fuel cell technology. The fuel cell stack 2 has a coolant inlet 3 and a coolant outlet 4 to which the coolant circuit 1 is connected, so that the coolant, particularly water, can flow out of the fuel cell stack 2 via the coolant outlet 4 into the coolant circuit 1, travels through the latter and, by way of the coolant inlet 3, enters the fuel cell stack 1 again. The coolant is thereby circulated in the coolant circuit 1.

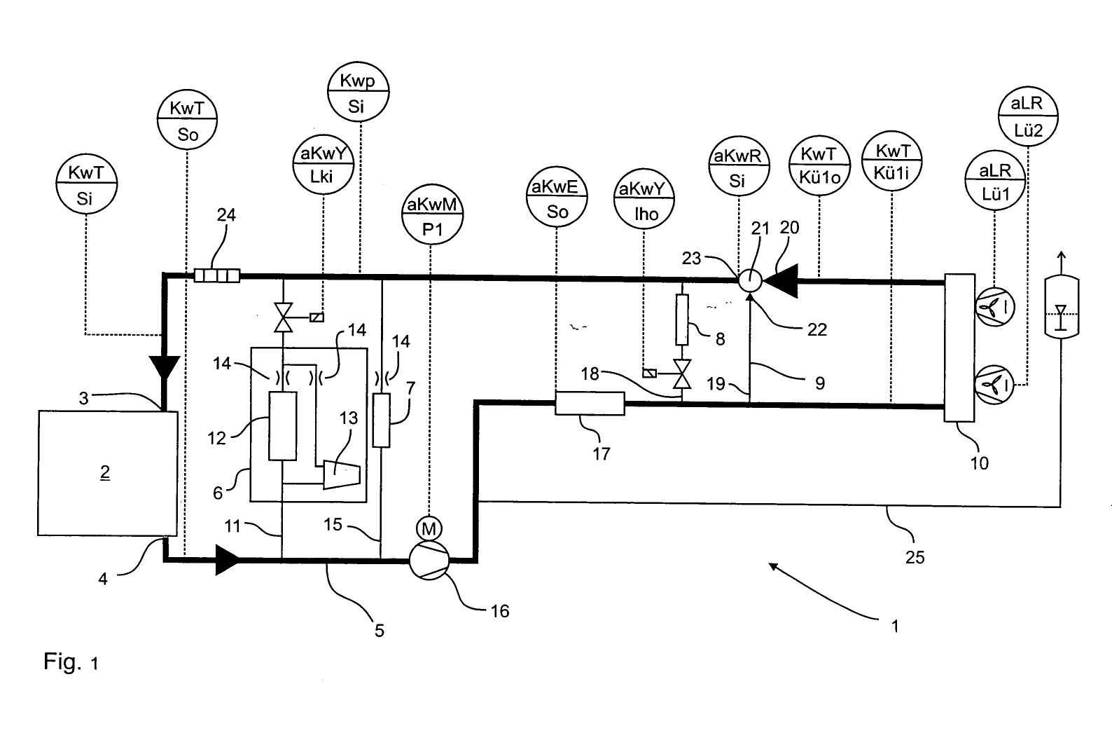

The coolant circuit 1 is a simple ring structure, with the ring 5 comprising a combination of pipe sections that form a maximal flow path for the coolant without any reversal of flow direction. In FIG. 1, the ring 5 is indicated by thicker lines.

A compression device 6, an ion exchanger device 7, an interior heating device 8 and a bypass pipe 9 are provided as intermediate connections in the ring 5. The above-mentioned intermediate connections are fluidically arranged parallel and/or antiparallel to one another in the ring 5, and parallel and/or antiparallel to a heat exchanger 10 that is serially integrated in the ring 5, as well as to the fuel cell stack 2.

The construction details of the coolant circuit will be explained in the following starting from the fuel cell stack 2 in the flow direction of the coolant.

Starting from the coolant outlet 4, the coolant is guided into the ring 5. A measuring device KwT-So (that is, cooling water temperature—stack out), which measures the temperature of the coolant flowing out of the fuel cell stack 2 and has a measuring range of from 40° C. to 130°, is arranged fluidically directly behind the coolant outlet.

Behind the measuring device KwT-So, a first intermediate connection branches off from the ring 5 by way of a first junction 11, which forms an inlet for the compression device 6. In the compression device 6, the coolant flow branched off the ring 5 is guided, via another branching, partly into a fuel cell oxidant (air) cooler 12 and partly into an oxidant compressor 13. The oxidant compressor 13 compresses the air that is taken in from the outside and fed as an oxidant to the fuel cell stack 2, for example as a function of the load. The temperature of the air increases as a result of the compression. Therefore, to reduce the temperature, on the one hand, mechanical components which come in thermal contact with the air to be compressed, particularly the rotors, are cooled by the coolant in the oxidant compressor 13 which is constructed, for example, as a rotary screw compressor. For a further reduction of the temperature, the compressed and precooled air is guided through the fuel cell oxidant cooler 12, which is also actively cooled by the coolant.

The coolant flow through the fuel cell oxidant cooler 12 and the oxidant compressor 13 can be statically or dynamically adjusted, by respective throttles 14 which are arranged behind the fuel cell oxidant cooler 12 and the oxidant compressor 13. Behind the throttles 14, the two partial flows are combined again and are guided by way of a first valve aKwY-Lki (actuator cooling water valve—air cooling in) into the ring 5 in the area of the inlet into the fuel cell stack 2. The first valve aKwY-Lki has a valve gear so that the flow of the coolant through the first connection pipe and thereby through the compression device 6 can be adjusted and/or controlled.

Behind the first junction 11, the remaining coolant flow is guided in the ring 5 to a second junction 15 which again couples a portion of the coolant flow out of the ring 5 and feeds it to the ion exchanger device 7. The ion exchanger device 7 removes interfering ions in the coolant and, in addition, demineralizes the coolant. Behind the ion exchanger device 7, the coolant is returned via another throttle 14 for the dynamic or static adjustment of the flow-through into the ring 5 in the flow direction in front of the coolant return out of the compression device 6.

In an alternative embodiment, the compression device 6 connected via the first junction 11 and/or the ion exchanger device 7 connected by way of the second junction 15 can preferably fluidically also be operated in another direction, so that the junction 11 and the junction 15 respectively form a drain for the compression device 6 and the ion exchanger device 7 respectively.

Starting from the second junction 15 and continuing to follow the flow direction of the coolant in the ring 5, a coolant pump 16 is provided, which is driven by a motor M that is controlled by a control device aKwM-P1 (actuator cooling water motor—P1). The coolant pump 16 moves the coolant through the coolant circuit 1.

A heating device 17 for raising the temperature of the coolant is arranged in the ring 5, serially in the flow direction, for example, directly behind the coolant pump 16, which arrangement of the heating device 17 has also been successful in the case of other designs of coolant circuits. The heating device 17 is controlled by a control device aKwE-So (actuator cooling water energy—stack out).

A third junction 18, which is provided downstream in the further course of the ring 5, guides a partial flow of the coolant by way of a second valve aKwY-Iho (actuator cooling water valve—interior heating device out) to the interior heating device 8. The second valve aKwY-Iho also has a valve gear so that the flow of the coolant through the interior heating device 9 can be controlled especially statically or dynamically. The interior heating device 8 is constructed as a heat exchanger and is used for the heating of the occupant compartment. Behind the interior heating device 8, the coolant flow is returned upstream directly in front of the return flow from the ion exchanger device 7 into the ring 5. The first valve aKwY-Lki as well as the second valve aKwY-Iho are open in the normal operation.

A fourth junction 19, which is arranged in the flow direction in the ring 5, behind the third junction 18, guides a partial flow into the bypass pipe 9. The not branched-off residual flow of the coolant arrives in the heat exchanger 10, is cooled there and, following the ring 5, is guided into a first inlet 20 of a 3-way valve 21, to whose second inlet 22 the bypass pipe 29 is connected. The outlet 23 of the 3-way valve guides the coolant by way of the ring 5 back to the fuel cell stack 2.

Respective measuring devices KwT-Küli (cooling water temperature cooler in) and KwT-Külo (cooling water temperature cooler out) are arranged in the flow direction, respectively in front of and behind the heat exchanger 10, for measuring the input and output temperature of the coolant. The heat exchanger 10 is optionally cooled by ventilators aLR-Lü1 and aLR-Lü2 (actuator ventilating control—ventilator 1 and 2 respectively).

The 3-way valve 21 mixes uncooled coolant from the bypass pipe 9 with cooled coolant from the radiator 10. Depending on the mixing ratio of the two partial flows, it is possible to obtain a temperature which is between that of the cooled and uncooled coolant, and to feed the coolant to the fuel cell stack 2 by way of the outlet 23. The change of the mixing ratio can be controlled at low energy expenditures and highly dynamically by controlling the 3-way valve by means of a control device aKwR-Si (actuator cooling water regulating—stack in).

The 3-way valve 21 is controlled based on a defined desired temperature for the coolant at the coolant inlet 4 of the fuel cell stack 2. For this purpose, a control device readjusts or automatically controls the coolant temperature on the basis of the desired temperature by controlling the 3-way valve 21. In the case of more complex control devices, the measured quantities of several or of all measuring devices illustrated in FIG. 1 are taken into account as additional input quantities. It is optionally provided that, in addition to the 3-way valve 21, the control device controls and/or regulates several or all of the actuators in FIG. 1, particularly the ventilators.

As additional components, the coolant circuit has a filter 24 directly in front of the coolant inlet 3 and an excess pressure device 25 behind the coolant pump 16, which excess pressure device 25 opens, for example, starting at an excess pressure of 0.8 bar.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMBERS

| | |
|---|---|
| 1 | Coolant circuit |
| 2 | fuel cell stack |
| 3 | coolant inlet |
| 4 | coolant outlet |
| 5 | ring |
| 6 | compression device |
| 7 | ion exchanger device |
| 8 | interior heating device |
| 9 | bypass pipe |
| 10 | heat exchanger |
| 11 | first junction |
| 12 | fuel cell air cooler |
| 13 | compressor |
| 14 | throttle |
| 15 | second junction |
| 16 | coolant pump |
| 17 | heating device |
| 18 | third junction |
| 19 | fourth junction |
| 20 | first inlet of 3-way valve |
| 21 | 3-way valve |
| 22 | second inlet of 3-way valve |
| 23 | outlet of 3-way valve |
| 24 | filter |
| 25 | excess pressure device |

What is claimed is:

1. An oxidant compression device for compressing an oxidant for a fuel cell stack, said oxidant compression device comprising:
an oxidant compressor for the compressing of the oxidant; and
an oxidant cooler for cooling compressed oxidant;
a common coolant circuit for said oxidant compressor and said oxidant cooler, said common coolant circuit having a coolant that flows through and cools both said oxidant compressor and said oxidant cooler.

2. The compression device according to claim 1, wherein the oxidant compressor and the oxidant cooler are fluidically connected parallel to one another in the coolant circuit.

3. The compression device according to claim 1, wherein the fuel cell stack is arranged fluidically parallel to the oxidant cooler.

4. The compression device according to claim 1, wherein the fuel cell stack is arranged fluidically parallel to at least one of the oxidant cooler, the oxidant compressor and additional components.

5. The compression device according to claim 1, wherein the oxidant compressor has a water injection cooling.

6. The compression device according to claim 1, wherein the oxidant compressor is constructed as a dry-operation compressor.

7. The compression device according to claim 1, which the oxidant compressor operates according to a displacement principle.

8. The compression device according to claim 1, wherein the oxidant compressor is constructed as a rotary screw compressor.

9. The compression device according to claim 6, wherein at least one rotor in the rotary screw compressor is cooled.

10. The compression device according to claim 1, wherein the oxidant cooler is constructed as a heat exchanger.

11. The compression device according to claim 1, wherein the connection between the coolant inlet for the compression device and the coolant inlet for the fuel cell stack is constructed without junctions.

12. The compression device according to claim 1, wherein a flow through at least one of the oxidant compressor and the oxidant cooler is adjustable by throttle devices.

13. The compression device according to claim 1, wherein the compression device has a valve device which, for shutting-off the coolant flow through the compression device, is independent of or uncoupled from the coolant flow through the fuel cell stack.

14. A method for compressing an oxidant gas that is supplied as a reactant of a fuel cell system, said method comprising:
an oxidant compressor compresses said oxidant gas;
an oxidant cooler cooling compressed oxidant gas from said compressor; and
cooling both said oxidant compressor and said oxidant cooler by a flow of coolant in a common coolant circuit.

15. The method according to claim 14, wherein coolant of said common coolant circuit flows in parallel through said oxidant compressor and said oxidant cooler.

16. A fuel cell system comprising:
a fuel cell stack which receives an input flow of an oxidant; and
an oxidant compression device; wherein:
said oxidant compression device, includes an oxidant compressor for compressing the oxidant, an oxidant cooler for cooling compressed oxidant and a common coolant circuit for said compressor and said oxidant cooler; and
said common coolant circuit receives a coolant that flows through and cools both said compressor and said oxidant cooler.

17. The method according to claim 16, wherein coolant of said common coolant circuit flows in parallel through said compressor and said oxidant cooler.
